(19) United States
(12) Patent Application Publication
(10) Pub. No.: US 2024/0066771 A1
(43) Pub. Date: Feb. 29, 2024

(54) cup having broken thread formed from a mold structure

(71) Applicant: Prime Molding Technologies, Inc., Riviera Beach, FL (US)

(72) Inventor: Richard Volpe, Palm Beach Gardens, FL (US)

(21) Appl. No.: 18/455,384

(22) Filed: Aug. 24, 2023

Related U.S. Application Data
(60) Provisional application No. 63/373,650, filed on Aug. 26, 2022.

(51) Int. Cl. B29C 45/26; B29C 45/44

(52) U.S. Cl. CPC B29C 45/2622; B29C 45/44; B29L 2031/7132

(57) ABSTRACT

A mold structure used in an injection molding process to form a cup having broken threads where an “A” and “B” mold form a horizontal irregular parting line to alleviate stripping or unscrewing along the threads. The “B” mold includes a series of segmented surfaces arranged in a helical pattern at an angle from a transverse plane and extending around a longitudinal axis to form a topside surface of the “B” mold. The “A” mold having a series of corresponding segmented surfaces similarly constructed and arranged to mate with the “B” mold. Closed-ended flutes are disposed on an inner wall surface of each segmented surface on either the “A” or “B” mold. A core insert is disposed within but having a space thereinbetween inner wall surfaces of the top and “B” mold and abutting the closed “A” mold portion and closed “B” mold portion creating a seal off.

### PRIORITY CLAIM

In accordance with 37 C.F.R. § 1.76, a claim of priority is included in an Application Data Sheet filed concurrently herewith. Accordingly, the present invention claims priority to U.S. Provisional Patent Application No. 63/373,650, entitled “*CUP HAVING BROKEN THREAD FORMED FROM A MOLD STRUCTURE”, filed Aug. 26, 2022. The contents of which the above referenced application is incorporated herein by reference.

### FIELD OF THE INVENTION

The present invention relates to the field of injection molding process molds and, more particularly, to an “A” mold, “B” mold, and a core insert used in the injection molding process to form a cup having broken threads where the “A” and “B” mold form a horizontal irregular parting line on the cup in order to alleviate stripping or unscrewing along the cup threads.

### BACKGROUND OF THE INVENTION

Injection molding is a manufacturing process for producing parts by injecting molten material into a mold. Injection molding can be performed with a host of materials mainly including metals, glasses, elastomers, confections, and most commonly thermoplastic and thermosetting polymers. Material for the part is fed into a heated barrel, mixed, and injected into a mold cavity, where it cools and hardens to the configuration of the cavity. Injection molding uses a special-purpose machine that has three parts: the injection unit, the mold, and the clamp. Parts to be injection-molded must be very carefully designed to facilitate the molding process; the material used for the part, the desired shape and features of the part, the material of the mold, and the properties of the molding machine must all be considered.

A parting line is an inevitable part of injection molded products. It is the line of separation between where two halves of a mold meet. It manifests itself on injection molded parts as a line that runs the entire perimeter of the part. In most parts, it is just a line that runs straight down the middle. However, in more complex parts, its location varies. While a parting line might seem harmless, it is very important in determining the usefulness of a part. This is because its position is influential in helping designers and molders to decide where to insert other features of the part. If a machinist places an important feature on the wrong side of the parting line, it could lead to serious issues with the whole injection molding process. Unfortunately, a parting line will almost always be present on the final product, but there are a few strategies to mitigate the look of a parting line on injection molded parts, such as camouflaging or masking the line by incorporating it with other parallel or linear features or locating the parting line under a protruding feature like a rim or cap.

According to the specific situation of some final molded products, the parting line is made stepped. For the stepped parting line, due to the large force on one side of the cavity, the injection eccentric force is generated on both sides of the cavity, which causes a relative sliding tendency between the fixed half and the moving half molds. If this unbalanced eccentric force is small, a guide pin can be used to support it. But if the eccentric force is too large, it will cause excessive wear of the guide pin and the guide bush and cause the decline in the quality of the plastic part. To compensate for the shortcoming, it is desired to machine mold cavities that are symmetrical. Thus, the injection forces received on both sides of the mold body are balanced.

A cup or container having interrupted threads are known in the art. For instance, U.S. Pat. No. 4,721,220 discloses a closure having interrupted threads, wherein the interruptions between thread segments are vertically aligned with and are at least as long as thread segments in the overlapping portions of the turns of the thread. This permits manufacture of the closure by stripping of the closure threads from a mold to obtain a higher rate of production while minimizing the pulled-thread defects previously encountered with this production method. U.S. Pat. No. 4,948,001 discloses a container having a neck finish which is provided with threads for receiving a closure and wherein the threads are blow molded in the formation of the container from a tubular parison. It has been found that in the blow molding of the threads, there is a thinning of the wall of the neck finish at the roots of the threads and, under certain circumstances, when a closure is applied at a high torque, there is an axial collapse of the neck finish, rendering the container unfit for use. The problem of axial collapse of the neck finish is overcome by interrupting the threads so as to provide axial beam strength at circumferential intervals around the neck finish.

What is needed in the art is a cup having broken thread formed in an injection molding process that utilizes a horizontal irregular parting line in to order to alleviate stripping along the cup threads.

### SUMMARY OF THE INVENTION

A mold structure compromising of an “A” mold, “B” mold, and core insert used in an injection molding process to form a cup having broken threads where the top and “B” mold form a horizontal irregular parting line on the cup in to order to alleviate stripping or unscrewing along the cup threads is disclosed. The mold structure for producing a cup having broken thread includes a “B” mold having a series of segmented surfaces arranged in a helical pattern extending around a longitudinal axis and forming a topside surface of the “B” mold, and the “A” mold having a series of corresponding segmented surfaces similarly constructed and arranged to mate with the “B” mold series of segmented surfaces. Close-ended flutes are disposed on an inner wall surface of at least each segmented surface on one of either the “A” mold or “B” mold to form the broken threads on the cup. The core insert is constructed and arranged to be disposed within but having a space thereinbetween inner wall surfaces of the “A” and “B” mold and abutting the “A” mold closed top portion and “B” mold closed bottom portion.

Accordingly, it is a primary objective of the instant invention to provide a cup having broken thread mold structure forming a horizontal irregular parting line along the segmented surface of the “B” mold in order to alleviate stripping and unscrewing along the container threads.

It is yet another objective of the instant invention to utilize a horizontal parting line that does not distort the broken threads because of stripping.

It is a further objective of the instant invention to provide a cost effective mold structure which only involves an “A” mold, “B” mold, and core insert.

It is still another objective of the instant invention to provide a cup having broken threads that tightens better than known cups having helical threads.

It is another objective of the instant invention to form a cup with broken threads to cooperate with and engage with the broken thread segments on a closure to retain the closure in a sealing relationship with the cup.

It is yet another objective of the instant invention to provide close-ended flutes having a specific angle from the transverse plane which forms the broken threads on the cup.

Other objects and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a perspective view of a cup having broken threads formed by the mold structure of the instant invention;

FIG. 2 is a perspective view of the “B” mold of the mold structure of the instant invention;

FIG. 3 is a perspective view of the “A” mold of the mold structure of the instant invention;

FIG. 4 is a perspective view of the core insert of the mold structure of the instant invention;

FIG. 5 is a perspective top view of the “B” mold of the mold structure of the instant invention;

FIG. 6 is a cross-sectional view of the “B” mold of the mold structure of the instant invention;

FIG. 7 is a cross-sectional view of the series of segmented surfaces of the mold structure of the instant invention;

FIG. 8 is a cross-sectional view of the series of segmented surfaces of the mold structure of the instant invention;

FIG. 9 is a cross-sectional view of the series of segmented surfaces of the mold structure of the instant invention; and

FIG. 10 is a perspective bottom view of an alternative embodiment of the “A” mold of the mold structure of the instant invention.

### DETAILED DESCRIPTION OF THE DRAWINGS

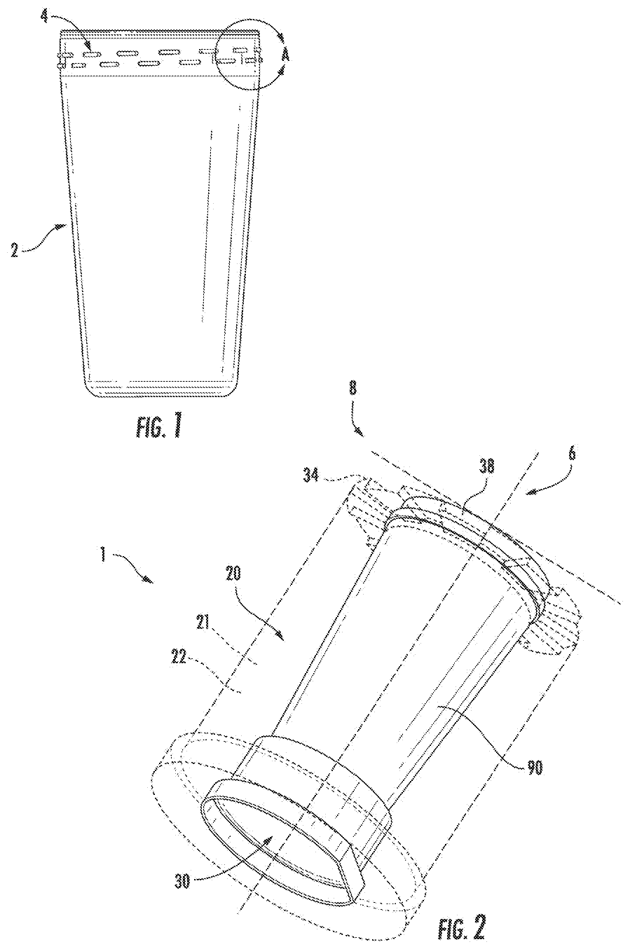

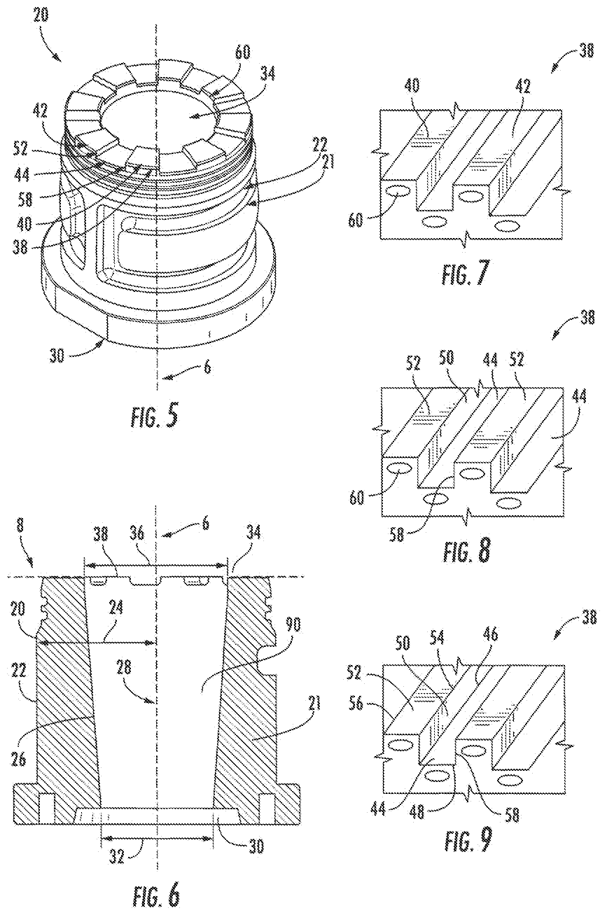

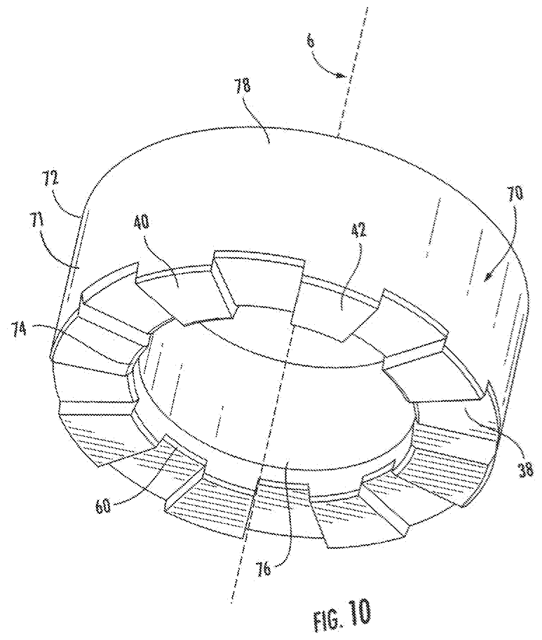

As shown in FIGS. 1-10, a cup 2 having broken threads 4 formed from a mold structure 1 comprised of an “A” mold 70, “B” mold 20, and a core insert 90 used in an injection molding process to form a cup 2 having broken threads 4 where the “A” mold 70 and “B” mold 20 align and form a horizontal irregular parting line 10 in to order to alleviate stripping or unscrewing along the cup threads 4.

As shown in FIGS. 2, 5 and 6, the “B” mold 20 having an annular body 21 with a longitudinal axis 6, an outer wall surface 22, inner wall surface 26, a closed bottom portion 30, and an open top portion 34. The outer wall surface 22 and inner wall surface 26 have an annular shape. The outer wall surface 22 has a radius 24 from the longitudinal axis 6 that is larger than the inner wall surface radius 28. The top portion 34 of the “B” mold 20 has a larger diameter 36 than the bottom portion diameter 32 to form an annulus.

As shown in FIGS. 5, and 7-9, the top portion 34 of the “B” mold 20 includes a series of segmented surfaces 38 extending around the top portion 34 about a transverse plane 8 and arranged in a helical pattern about the longitudinal axis 6. A series is defined as a pattern of repeatable segmented surfaces. The series of segmented surfaces is defined by an uppermost segmented surface 40 that abuts the transverse plane 8, and a plurality of sequential segmented surfaces 42 being a gradual downward distance from the transverse plane 8 and the adjacent previous segmented surface. All segmented surfaces 38 are comprised of a bottom surface 44, a first wall 50, a top surface 52, and a second wall 58. The bottom surface 44 and top surface 52 extend from the inner wall surface 26 of the “B” mold 20 to the outer wall surface 22 of the “B” mold 20. The first wall 50 extends from a first bottom surface edge 46 to a top surface edge 54. The second wall 58 is in an opposite direction from the first wall 50 and extends from an opposite top surface edge 56 to an opposite bottom surface edge 48 of the sequential segmented surface 42.

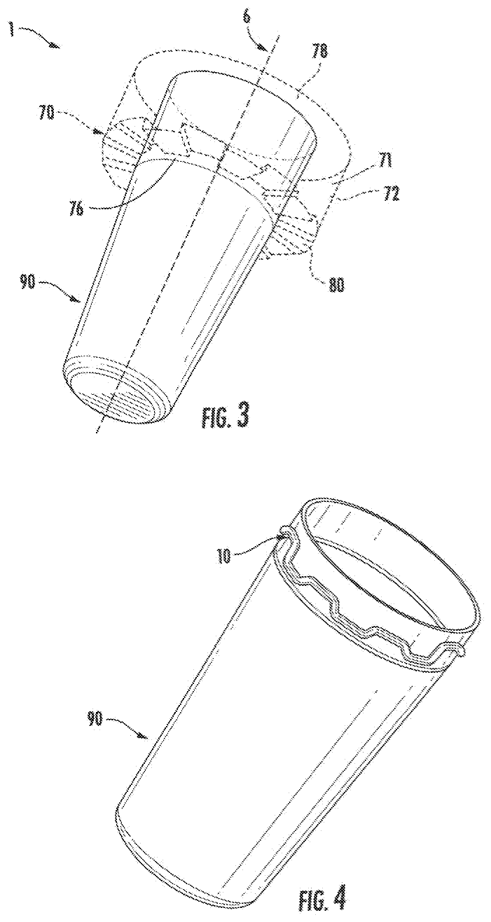

As shown in FIGS. 3 and 10, the “A” mold 70 having an annular body 71 that shares the longitudinal axis 6 with the “B” mold 20 and includes an outer wall surface 72, an inner wall surface 74, an open bottom portion 76, and a closed top portion 78. The open bottom portion 76 of the “A” mold 70 has a corresponding series of segmented surfaces 80 constructed and arranged to mate with the “B” mold series of segmented surfaces 38. The “A” mold 70 further includes a lip 82 extending around the inner wall surface 74 (not shown). As shown in FIG. 10, in an alternative embodiment, it is contemplated that the closed-ended flutes are displaced on the “A” mold rather than the “B” mold.

As shown in FIGS. 7-9, the sequential segmented surfaces 42 on the “B” mold 20 are a downward distance of 12 degrees from the adjacent previous segmented surface 42. Specifically, the top surface 52 and the bottom surface 44 of the series of sequential segmented surfaces 42 on the “B” mold 20 are 12 degrees from the top surface 52 and bottom surface 44 of adjacent previous segmented surface 42, thereby making the corresponding segmented surfaces 80 on the “A” mold 70 12 degrees in the opposite direction to allow the “A” mold 70 and “B” mold 20 to mate. Although 12 degree is the preferred downward distance it is contemplated that any distance or degree can be applied in construction thereof.

Closed-ended flutes 60 on each inner wall surface, 26 or 74, correspond to each top surface 52 and bottom surface 44 of each segmented surface, 38 or 80, on one of either the “A” mold 70 or “B” mold 20. Each closed-ended flute 60 is shaped like a single thread 4. Each closed-ended flute 60 is located nearest each top surface 52 and bottom surface 44 on each series of segmented surfaces, 38 or 80. Because the closed-ended flutes 60 are located nearest each top surface 52 and bottom surface 44 on each series of segmented surfaces, 38 and 80, as well as being aligned with such, the closed-ended flutes 60 are also a downward distance of 12 degrees from the adjacent previous segmented surface.

As shown in FIG. 4, the core insert 90 is constructed and arranged to be disposed within the “A” mold 70 and “B” mold 20 but having a space 92 (not shown) thereinbetween the inner wall surfaces, 74 and 26, of the “A” mold 70 and the “B” mold 20 and abuts the “A” mold closed top portion 78 and the “B” mold closed bottom portion 30 to create a seal off.

During the injection molding process, the “B” mold 20 and “A” mold 70 form a horizontal parting line 10 on the cup 2. Specifically, the “B” mold top portion series of top surfaces 52 and the “A” mold series of corresponding top surfaces 80 form said parting line 10 on the cup 1. The parting line 10 is irregular and following the pattern set by the series of segmented surfaces, 28 and 80.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A mold structure for producing a cup having broken threads comprising:
a “B” mold having an annular body with a longitudinal axis comprising of an outer wall surface, an inner wall surface, a closed bottom portion, and an open top portion; said annular body having a first radius from said longitudinal axis to said inner wall surface and a second radius from said longitudinal axis to said outer wall surface, wherein said second radius is larger than said first radius; said open top portion having a larger diameter than said closed bottom portion; said open top portion having a series of segmented surfaces on said annular body about a transverse plane and arranged in a helical pattern about said longitudinal axis, said series of segmented surfaces defined by an uppermost segment abutting said transverse plane and a plurality of sequential segmented surfaces, wherein each sequential segmented surface being a downward distance from an adjacent previous segmented surface; each said segmented surface having a top surface, bottom surface, a first wall, and a second wall, said bottom and top surfaces extending from said inner wall surface to said outer wall surface, said first wall extending from a first bottom surface edge to a top surface edge and said second wall positioned opposite from said first wall from an opposite top surface edge to a second bottom surface edge of said sequential segment;
an “A” mold having an annular body with a longitudinal axis, wherein said “A” mold longitudinal axis is the same as said “B” mold longitudinal axis, said “A” mold having an outer wall surface, an inner wall surface, an open bottom portion, and a closed top portion; said open bottom portion having a corresponding series of segmented surfaces constructed and arranged to mate with said “B” mold series of segmented surfaces;
a plurality of closed-ended flutes on said inner wall surface of either said “A” mold or said “B” mold; and
a core insert constructed and arranged to be disposed within said inner wall surfaces of said “A” mold and said “B” mold and having a space thereinbetween, said core insert abutting said “A” mold closed top portion and said “B” mold closed bottom portion;
wherein said “A” mold, said “B” mold, and said core insert form a cup having broken threads during an injection molding process without stripping or unscrewing.

2. The mold structure for producing a cup having broken threads of claim 1, wherein said “B” mold and said “A” mold align and form a horizontal parting line on said cup.

3. The mold structure for producing a cup having broken threads of claim 2, wherein said horizontal parting line being irregular and following a pattern of said series of segmented surfaces.

4. The mold structure for producing a cup having broken threads of claim 3, wherein said “B” mold series of segmented surfaces and said “A” mold corresponding series of segmented surfaces form said irregular horizontal parting line on said cup.

5. The mold structure for producing a cup having broken threads of claim 1, wherein each said sequential segmented surface on said “B” mold being 12 degrees downward distance from said adjacent previous segmented surface.

6. The mold structure for producing a cup having broken threads of claim 5, wherein said top surface and said bottom surface of said series of sequential segmented surfaces on said “B” mold being 12 degrees from said top surface and said bottom surface of said adjacent previous segmented surface.

7. The mold structure for producing a cup having broken threads of claim 6, wherein said plurality of closed ended flutes on said “B” mold corresponding and aligned with said top surface and said bottom surface of said series of segmented surfaces.

8. The mold structure for producing a cup having broken threads of claim 1, wherein said plurality of closed ended flutes on said “B” mold corresponding and aligned with said top surface and said bottom surface of said series of segmented surfaces.

9. The mold structure for producing a cup having broken threads of claim 1, wherein said plurality of closed ended flutes on said “A” mold corresponding and aligned with said corresponding series of segmented surfaces.
